(19) United States
(12) Patent Application Publication
(10) Pub. No.: US 2026/0225069 A1
(43) Pub. Date: Aug. 6, 2026

(54) Charged Sorbent Material

(71) Applicant: Cambridge Enterprise Limited, Cambridge, Cambridgeshire (GB)

(72) Inventors: Alexander Forse, Cambridge, Cambridgeshire (GB); Huaiguang Li, Cambridge, Cambridgeshire (GB); Helen Eastmond, Cambridge, Cambridgeshire (GB)

(21) Appl. No.: 19/159,093

(22) PCT Filed: Feb. 29, 2024
(86) PCT No.: PCT/EP2024/055184

§ 371 Date: Aug. 22, 2025

(30) Foreign Application Priority Data
Mar. 3, 2023 (GB) 2303149.5
Dec. 18, 2023 (GB) 2319446.7

(51) Int. Cl. B01J 20/26; B01D 53/62; B01J 20/20

(52) U.S. Cl. CPC B01J 20/261; B01D 53/62; B01J 20/20; B01D 2253/102; B01D 2253/202; B01D 2253/306; B01D 2257/108; B01D 2257/504; B01D 2258/01; B01D 2258/0283

(57) ABSTRACT

In general terms this invention relates to a charged sorbent material. In particular, though not exclusively, this invention relates to a charged sorbent material comprising a porous carbon material and charged non-carbon particles within the pores of the porous carbon material. The invention also relates to a method of making a charged sorbent material, and a process of removing an adsorbate from a fluid by contacting it with the charged sorbent material.

### TECHNICAL FIELD

In general terms this invention relates to a charged sorbent material. In particular, though not exclusively, this invention relates to a charged sorbent material comprising a porous carbon material and charged non-carbon particles within the pores of the porous carbon material. The invention also relates to a method of making a charged sorbent material, and a process of removing an adsorbate from a fluid by contacting it with the charged sorbent material.

### RELATED APPLICATIONS

This application claims priority to, and the benefit of, GB 2303149.5 filed on 3 Mar. 2023 (3 Mar. 2023) and GB2319446.7 filed on 18 Dec. 2023 (18 Dec. 2023). The contents of both priority applications are incorporated by reference in their entirety.

### BACKGROUND

There is an urgent need for improved sorbent materials for the capture of carbon dioxide from the atmosphere, known as “direct air capture”, and in particular low cost materials that can be regenerated using renewable electricity. Beyond direct air capture, new sorbents are also being developed for the capture of carbon dioxide from industrial flue gases.

There is also a need for improved sorbent materials for the capture of other pollutants, such as hydrogen sulfide and oxides of nitrogen (known collectively as “NOx”) from emissions sources such as chemical plants, power plants (in particular fossil fuel power plants), and mobile emissions sources such as cars and planes. Existing direct air capture solutions, in particular, all have significant drawbacks. The use of liquid solutions of sodium or potassium hydroxides for carbon capture have been described in the literature (“CO₂ separation using bipolar membrane electrodialysis”, Matthew D. Eisaman et al, Energy Environ. Sci., 2011, 4, 1319-1328), but liquid solutions are impractical for large scale use. The requirement for large volumes of water for this purpose is also in conflict with environmental benefits. There therefore remains a need for improved sorbent materials that may be particularly suitable for use in environmental applications.

### SUMMARY OF THE INVENTION

A first aspect of the invention is a charged sorbent material, comprising
a charged porous electrically conducting material; and
charged particles within the porous electrically conducting material;
wherein the porous electrically conducting material comprises one or more of a carbon material, a metal organic framework (MOF), a covalent organic framework (COF), one or more organic or inorganic binders, or a conducting polymer.

A second aspect of the invention is a method of making a charged sorbent material, comprising
contacting an uncharged porous electrically conducting material with an electrolyte solution;
electrically connecting the uncharged porous electrically conducting material to an electrode; and
applying an electric potential across the uncharged porous electrically conducting material and the electrode to form a charged porous electrically conducting material.

A third aspect of the invention is a charged sorbent material obtained or obtainable by the method as hereinbefore defined.

A fourth aspect of the invention is a process of removing an adsorbate from a fluid, comprising contacting a fluid containing the adsorbate with the charged sorbent material as hereinbefore defined.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description, and in particular the individual features thereof, may be taken independently or in any combination. That is, all embodiments and/or features of any embodiment can be combined in any way and/or combination, unless such features are incompatible.

### BRIEF DESCRIPTION OF DRAWINGS

FIG. 1 is a schematic of the preparation of charged sorbent materials of the present invention.

FIG. 2 shows ¹H solid-state NMR (9.4 T) spectra of PCS-OH and control samples, acquired at a MAS rate of 12.5 kHz.

FIG. 3 shows CO₂ adsorption (filled data points) and desorption (hollow data points) isotherms of PCS-OH and control samples at 25° C., and CO₂ uptake of PCS-OH and control samples at 0.4 mbar and 25° C. Standard deviations are calculated from 5 independent samples.

FIG. 4 shows CO₂ adsorption isotherms of PCS-OH made from YP80F activated carbon film (referred to as PCS-OH (YP80F)) and control sample of YP80F activated carbon film at 25° C., and CO₂ uptake of PCS-OH (YP80F) and control sample of YP80F activated carbon film at 0.4 mbar and 25° C.

FIG. 5 shows dry, pure CO₂ uptake curves at 40° C. at 1 bar CO₂ for PCS-OH after activation under flowing dry N₂ at 40° C. for 1 h, after exposure to flowing dry air (~21% O₂ in N₂) at 100° C. for 12 h, and after exposure to flowing dry air (~21% O₂ in N₂) at 150° C. for 12 h.

FIG. 6 shows cycling capacities for 150 adsorption/desorption cycles for the PCS-OH in a simulated temperature-pressure swing adsorption process. Adsorption: 30° C., 20 min, dry 30% CO₂ in N₂; Desorption: 100° C., 20 min, pure N₂.

FIG. 7 shows cycling capacities of DAC for 10 adsorption/desorption cycles for PCS-OH. Adsorption: 30° C., 60 min, 400 ppm CO₂ in Air; Desorption: 130° C., 60 min, 100% N₂. The cycled capacity (difference) is shown.

FIG. 8 shows DAC by PCS-OH and control samples in a sealed box with 37% RH. The mass of PCS-OH is 120 mg.

FIG. 9 shows ¹³C ssNMR spectra of sorbents with ¹³CO₂ gas dosing at 0.9 bar: fresh sorbents with saturated CO₂ adsorption; after exposure to the air for 20 min, without joule heating; and after 20 min Joule heating. MAS rate of 12.5 kHz.

FIG. 10 shows Cycling capacities of DAC for the PCS-OH with Joule heating regeneration. The RH of DAC tests were controlled by desiccant (silica gel) at 11% at 25° C. The mass of PCS-OH is 30 mg.

FIG. 11 shows results of titration of PCS-OH samples (88 mg pieces) with 0.1 M HCl at 25° C. PCS-OH 0.565 and PCS-OH 0.365 refer to the samples of PCS-OH prepared at 0.565 V and 0.365 V for 4 h, respectively. Standard deviations are calculated from 2 independent samples.

FIG. 12 shows a ss¹³C NMR (9.4 T) spectrum of PCS-OH prepared with a positive potential of 0.365 V vs. SHE (standard hydrogen electrode), and loaded with ¹³CO₂ gas at a pressure of 0.9 bar. A 3.2 mm magic angle spinning HXY probe was used, with a one-pulse ¹³C experiment, and the sample spinning rate was 12.5 kHz. The recycle delay was set to be sufficiently long to ensure the spectrum was quantitative.

FIG. 13 (a) shows CO₂ uptake (25° C.) of PCS-OH and a “dripped cloth” sample prepared according to the examples; FIG. 13 (b) shows the low-pressure region of the data in FIG. 13 (a).

FIG. 14 shows results of cycling capacities for 150 adsorption/desorption cycles for the PCS-OH in a simulated temperature-pressure swing adsorption process. Adsorption: 30° C., 20 min, dry 30% CO₂ in N₂; Desorption: 100° C., 20 min, dry 30% CO₂ in N₂.

FIG. 15 shows CO₂ uptake curves at 40° C. and 1 bar CO₂ for PCS-OH before and after a period of sample storage in air for 14 months.

FIG. 16 shows direct air capture uptake kinetics measured by thermogravimetric analysis. In FIG. 16(a), data are shown for PCS-OH, 30° C., 90 mL/min gas flow, 400 ppm CO₂ in air after 14 months of storage. In FIG. 16(b), data are shown for: PCS-OH (14 months after sample preparation, this work), 30° C., 90 mL/min gas flow, 400 ppm CO₂ in air; Zn—(ZnOH)₄(bibta)₃ metal-organic framework, 27° C., 50 mL/min gas flow, 395 ppm of CO₂, 21% O₂, N₂ balance. (Bien, C. E. et al. Bioinspired metal-organic framework for trace CO2 capture. J. Am. Chem. Soc. 140, 12662-12666 (2018)); PEI/MMO composite (PEI67/Mg0.55Al—O), 25° C., 100 mL/min gas flow, 400 ppm CO₂ in N₂ (Zhu, X. et al. Efficient CO2 capture from ambient air with amine-functionalized Mg—Al mixed metal oxides. J. Mater. Chem. A 8, 16421-16428 (2020)); and PEI/SBA-15 composite (PEI67/SBA-15), 25° C., 100 mL/min gas flow, 400 ppm CO₂ in N₂(Zhu, X. et al. Efficient CO2 capture from ambient air with amine-functionalized Mg—Al mixed metal oxides. J. Mater. Chem. A 8, 16421-16428 (2020)).

FIG. 17a shows CO₂ uptake of PCS-OH in various relative humidity (RH) conditions in air. FIG. 17b shows CO₂ uptake of PCS-OH in various relative humidity at 0.9 bar CO₂.

FIG. 18 shows Adsorption microcalorimetry measurements of the differential molar adsorption heats curves related to the adsorption of CO₂ at 30° C. on PCS-OH (grey) and blank cloth (green). The dotted horizontal line represents the standard molar enthalpy of liquefaction of CO₂ at 30° C.: −17 kJ mol⁻¹. Inset: volumetric isotherms obtained by performing CO₂ adsorption at 30° C. on PCS-OH (grey) and blank cloth (green) with the volumetric line coupled to the microcalorimeter.

### DETAILED DESCRIPTION OF THE INVENTION

A first aspect of the invention is a charged sorbent material. The charged sorbent material comprises a charged porous electrically conducting material, and charged particles within the porous electrically conducting material. The charged porous electrically conducting material comprises one or more of a carbon material, a metal organic framework (MOF), a covalent organic framework (COF), one or more organic or inorganic binders, or a conducting polymer.

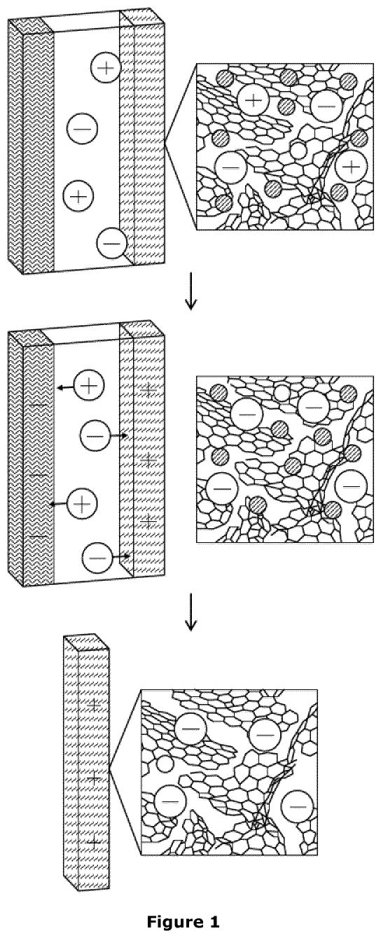

U.S. Pat. No. 9,206,945 B2 discloses a hydrogen storage system. In U.S. Pat. No. 9,206,945, a sorbent material containing a hydrogen splitting catalyst is discussed. When the hydrogen is absorbed, the catalyst splits the hydrogen molecules into protons. The sorbent material with the protons stored therein is a “charged sorbent” due to the presence of proton ions (see e.g. FIG. 1). The ‘charged sorbent’ in U.S. Pat. No. 9,206,945B2 refers to the material after components have been stored. The ‘charged sorbent’ in U.S. Pat. No. 9,206,945B2 is not capable of storing further components.

JP 2002136838 discloses a method of storing CO₂ using a carbon based absorbent doped with boron, silicon, phosphorus or sulfur to increase absorption (see [0011]). The carbon materials are treated using a direct current to alter the polarity of the material, enabling the capture and release of CO₂. The absorption in JP 2002136838 does not utilise charged particles accumulated in the pores of a charged sorbent material.

In one preferred embodiment of the invention, the charged porous electrically conducting material comprises a carbon material. The carbon material may comprise any allotrope of carbon, or a mixture of allotropes of carbon. Preferred allotropes of carbon in the carbon material are those that have relatively high electrical conductivity when compared to other carbon allotropes. In particular, the carbon material preferably comprises graphite, graphene, carbon nanotubes, amorphous carbon, polycrystalline carbon, carbon black, activated carbon, or mixtures thereof.

The carbon material preferably comprises activated carbon. Activated carbon is particularly suitable for use in the present invention due to its conductivity, high porosity and high surface area. These properties are particularly advantageous in the context of the present invention as they result in a material that has a relatively large (i.e. when compared to other forms of carbon) available surface area for bonding with charged non-carbon particles, and are sufficiently porous that a large proportion of this large surface area is accessible to such charged non-carbon particles by, for example, diffusion.

Particularly preferably, the charged porous electrically conducting material comprises a carbon material, the carbon material comprises activated carbon, and the carbon material comprises an activated carbon fiber cloth. Thus one preferred embodiment of the invention is a charged sorbent material, comprising a charged porous electrically conducting material; and charged particles within the porous electrically conducting material; wherein the charged porous electrically conducting material comprises a carbon material, wherein the carbon material is an activated carbon fiber cloth.

The activated carbon fiber cloth preferably has a specific surface area of from 500 to 3500 m²/g. Particularly preferably the activated carbon fiber cloth has a specific surface area of from 600 to 3000 m²/g, more preferably from 700 to 2500 m²/g, even more preferably from 800 to 2000 m²/g, e.g. from 850 to 1500 m²/g, more preferably from 900 to 1100 m²/g. The activated carbon fiber cloth preferably has a specific surface area of about 700 m²/g, about 750 m²/g, about 800 m²/g, about 850 m²/g, about 900 m²/g, about 950 m²/g, about 1000 m²/g, about 1050 m²/g, or about 1100 m²/g.

In one embodiment of the invention, the charged porous electrically conducting material comprises a metal organic framework (MOF). Metal organic frameworks (MOFs) have garnered significant interests in the last two decades due to their promising potential in many applications such as gas adsorption, separation, catalysis and sensing. Compared with other porous materials such as zeolites and mesoporous silica, MOFs are based on crystalline porous structures tunable on the atomic scale, which can be designed and functionalized by judicious choice of metal nodes and modification of the organic linkers. However, one of the limitations of most MOFs is their low chemical stability, which undoubtedly hampers their application in industry. A rule of thumb for the construction of stable MOFs comes from the simple Hard and Soft Acid and Base Theory, which guides the selection of the metal-ligand combination for a MOF. For example, see Pearson, R. G. J. Am. Chem. Soc. 1963, 85, 3533. Because the carboxylate group is a hard Lewis base, hard Lewis acids such as Fe³⁺, Cr³⁺, Zr⁴⁺ and Ti⁴⁺ are usually considered good candidates for the construction of robust MOFs.

An example of the synthesis of MOF materials is described in European patent EP3514159B1.

In one embodiment of the invention, the charged porous electrically conducting material comprises a covalent organic framework (COF). Covalent-organic framework (COF) materials are classes of materials that have structures created mostly or completely by covalent bonds using light, non-metallic elements such as carbon, nitrogen, hydrogen, oxygen, boron, silicon, phosphorus and sulphur. There are some similarities in porous structure to metal-organic framework (MOF) materials, but generally the chemistry and resulting structures, properties and behaviours are different to MOFs, and accordingly, manufacturing and processing conditions used for the manufacture of MOF materials are not necessarily applicable to manufacture and production of COF materials.

Due to the strength of the covalent bonds, some COFs can display high levels of chemical stability. This makes them highly interesting as gas storage materials. COFs can contain structures which are fundamentally 2-D (like graphite) or 3-D (like diamond). The distinction between 2-D and 3-D structures is a fundamental difference between COFs, especially for their physical stability. They can be synthesised under realistic and practical mild conditions under a variety of techniques including solution-based and mechano-synthetic routes. This is in contrast to MOF materials, which are bonded together by coordinative linkages, and thus generally have far lower levels of chemical stability.

COF materials may be produced by solution-based synthesis routes. These processes typically result in production of fine powders. An example of the synthesis of COF materials is described in European patent application EP4031277A1.

In one embodiment of the invention, the charged porous electrically conducting material comprises:
i) a conducting polymer, or one or more organic or inorganic binders; and
ii) activated carbon particles.

In the context of the present disclosure, a conducting polymer is one that has an electrical conductivity in the range of from 10⁻¹² to 10⁶ S/cm. Alternatively, a conducting polymer may be a polymer that has an electrical resistivity in the range of from 10⁻⁶ to 10¹² Ω·cm.

In the context of the present disclosure, “polymer” refers to a macromolecule consisting of two or more structural repeat units.

“Synthetic polymer precursor” or “polymer precursor” refers to the compound used to prepare the synthetic polymer. Examples of polymer precursors that may be used in the conducting polymer as described herein include, for example, methanal (formaldehyde); Ethanal (acetaldehyde); Propane (propionaldehyde); Butanal (butyraldehyde); Glucose; Aldehydes such as benzaldehyde and cinnamic aldehyde (ie, HC(═O)R, wherein R is an organic group). Other exemplary polymer precursors include phenolic compounds such as phenol and polyhydroxy benzenes such as dihydroxy or trihydroxy benzenes such as resorcinol (i.e. 1,3-dihydroxy benzene), cate Kohl, hydroquinone and phloroglucinol.

“Polymer gel” refers to a gel in which the network constituent is a polymer, and generally the polymer gel is a wet (aqueous or non-aqueous) three-dimensional structure consisting of a polymer formed from a synthetic precursor or a polymer precursor.

Organic or inorganic binders as described herein include, for example, PTFE (polytetrafluoroethylene, Teflon), PFA (perfluoroalkoxy polymer resin, also known as Teflon), FEP (fluorinated ethylene propylene, Teflon), ETFE (sold as polyethylenetetrafluoroethylene, Tefzel and Fluon), PVF (sold as polyvinyl fluoride, Tedlar), ECTFE (polyethylenechlorotrifluoroethylene, Sold as Halar), PVDF (sold as polyvinylidene fluoride, Kynar), PCTFE (sold as polychlorotrifluoroethylene, Kel-F, and CTFE) Fluoro polymers such as trifluoroethanol, and combinations thereof.

Conducting polymers as described herein may optionally comprise one or more organic or inorganic binders, e.g. one or more organic or inorganic binders as described above.

“Activated carbon particles” refers to particles of activated carbon as described above.

The charged sorbent of the present invention comprises a charged porous electrically conducting material; and charged particles within the porous electrically conducting material. The charged particles are preferably selected from organic anions, inorganic anions, organic cations, and inorganic cations.

The charged particles that are suitable for use in the present invention are preferably organic anions or inorganic anions selected from the list comprising hydroxide, fluoride, chloride, bromide, iodide, carbonate, or bicarbonate. For the avoidance of doubt, this list is non-limiting.

In one particularly preferred embodiment of the invention, the charged particles comprise hydroxide anions and even more preferably are hydroxide anions.

Without wishing to be bound by theory, it is envisaged that when the charged particles comprise carbonate and/or bicarbonate, in the presence of water (such as a water-containing solution, e.g. a water-containing electrolyte solution, or in air) the carbonate and/or bicarbonate will be in equilibrium with hydroxide anions via hydrolysis of the carbonate and/or bicarbonate groups. Therefore in some embodiments of the invention, carbonate and/or bicarbonate charged particles may be considered to be partially or fully functionally equivalent to hydroxide anions.

In a similar manner, the charged particles may comprise an alcohol functional group that is covalently bonded to a chemical group that may be removed, in use, to expose a hydroxide or alkoxide functional group. Thus “protective groups” (or “protecting groups”) that are known in the art to be used in this manner may be used as functional equivalents to hydroxide anions when incorporated into the charged sorbent of the present invention. The skilled person is aware of suitable protecting groups (or protecting groups) that may be used with alcohol or hydroxide functional groups.

In one embodiment of the invention, the charged particles are cations. Preferably the cations are inorganic cations of lithium, sodium, potassium, rubidium, caesium, beryllium, magnesium, calcium, strontium, or barium.

The charged particles for use in the present invention may be complex anions or cations. The charged particles may comprise or consist of a coordination complex, i.e. a metal ion coordinated to one or more ligands. The charged particles may be monovalent ions or multivalent ions. Multivalent ions may be preferred as they contain more potential adsorption sites per metal centre than a monovalent anion. For example, alkali metal, alkaline earth metal or transition metal hydroxides such as zinc(II) hydroxide, Zn(OH)₂, or Al(III) hydroxide, Al₃(OH)₃, may be bonded or coordinated to the porous electrically conducting material through the Zn metal atom, which provides two hydroxide anions as potential adsorption sites per mole of Zn(OH)₂.

The function of the charged particles, e.g. cations or anions, is to electrostatically interact with adsorbed species, such that the adsorption capacity of the charged porous electrically conducting material with respect to that species is increased relative to the adsorption capacity of the same material in the absence of the charged particles. In this way the charged sorbent material may be suitable for use as an adsorbent for one or more chemical species, such as carbon dioxide, flue gases, or other exhaust gases and/or atmospheric pollutants.

The charged sorbent materials of the present invention may therefore be suitable for use as adsorbents in a number of applications, such as stationary emissions sources (e.g. power plants, chemical plants), mobile emissions sources (e.g. internal combustion engines), and so on. The charged species for use in the charged sorbent materials of the present invention may therefore be selected in order to selectively, preferentially, or efficiently adsorb a targeted chemical species. In a particularly preferred embodiment of the invention, the charged sorbent material is suitable for the adsorption of carbon dioxide. A preferred charged species for the adsorption of carbon dioxide is hydroxide anions (or precursors or equivalents thereof, as described above). Particularly preferably the charged sorbent material is capable of adsorbing carbon dioxide at atmospheric temperature and pressure. Even more preferably, the charged sorbent material is capable of adsorbing carbon dioxide at atmospheric temperature and pressure from air. Thus the charged sorbent materials of the inventions may be suitable for use in direct air capture (DAC) of carbon dioxide.

A second aspect of the invention is a method of making a charged sorbent material, comprising contacting an uncharged porous electrically conducting material with an electrolyte solution; electrically connecting the uncharged porous electrically conducting material to an electrode; and applying an electric potential across the uncharged porous electrically conducting material and the electrode to form a charged porous electrically conducting material.

Preferably the charged sorbent material is a charged sorbent material according to the first aspect of the invention.

Preferably the uncharged porous electrically conducting material is a porous electrically conducting material as hereinbefore described in relation to the first aspect of the invention.

The electrolyte solution is a solution comprising a solvent and dissociated cations and anions. At least one of the dissolved cations and anions is the charged particles of the first aspect of the present invention. The electrolyte solution may be a solid electrolyte solution or a liquid electrolyte solution, and preferably is a liquid electrolyte solution. Preferably the liquid electrolyte solution comprises a solvent selected from an organic solvent, a halogenated solvent, an aqueous solvent, or an ionic liquid.

The organic solvent may be an alcohol (e.g. a C1-C20 alcohol such as methanol, ethanol, a propanol, a butanol, a pentanol, a hexanol, a heptanol, or a diol or triol such as ethylene glycol or propylene glycol); an ether (e.g. diethyl ether, tetrahydrofuran, 1,4-dioxane, methyl tert-butyl ether, dimethoxyethane); an ester (e.g. methyl acetate, ethyl acetate, propylene carbonate); or an amide (e.g. dimethylformamide, N-methyl-2-pyrrolidone).

The halogenated solvent may be chloroform, dichloromethane, dichloroethane, or a polyfluorinated or perfluorinated hydrocarbon.

The aqueous solvent may be any mixture of water and a water-miscible solvent. Preferably the aqueous solvent consists essentially of, more preferably consists of, water. Preferably the water is distilled water. More preferably the water is deionised water.

The ionic liquid may be any ionic liquid known in the art, such as (but not limited to) BF₄ or PF₆ salts of nitrogen-containing heterocycles, e.g. imidazolium.

The electrolyte solution may comprise one or more additives, such as solubility aids or stabilisers. The electrolyte solution may comprise salts of hexafluorophosphate or tetrafluoroborate as an additive.

The concentration of the charged particles in the electrolyte is preferably in the range of from 0.1 to 10 mol/L, preferably from 0.5 to 8 mol/L, more preferably from 1 to 7 mol/L, e.g. about 1 mol/L, about 2 mol/L, about 3 mol/L, about 4 mol/L, about 5 mol/L, about 6 mol/L, or about 7 mol/L. Particularly preferably the concentration of charged particles in the electrolyte is in the range of from 5 to 7 mol/L, for example about 6 mol/L.

The method of making a charged sorbent material of the invention comprises electrically connecting the uncharged porous electrically conducting material to an electrode; and applying an electric potential across the uncharged porous electrically conducting material and the electrode to form a charged porous electrically conducting material.

Without wishing to be bound by theory, it is thought that the application of an electrical potential across the uncharged porous electrically conducting material and the electrode results in ionic migration of the charged particles present in the electrolyte into the porous structure of the uncharged porous electrically conducting material to thus form a charged porous electrically conducting material. For example, the application of a positive electric potential (with reference to a reference electrode) results in the migration of anions (i.e. charged particles as hereinbefore described) into the porous structure of the electrically conducting material.

Preferably in this charging step, the (initially) uncharged porous electrically conducting material has an applied potential of in the range of between +0.1 and +10 V with respect to a reference electrode, preferably between +0.2 and +5 V, more preferably between +0.3 and +1 V, e.g. about +0.3V, about +0.4 V, about +0.5 V, or about +0.6 V. Particularly preferably the applied potential is about +0.4 V with respect to a reference electrode. The use of an applied positive potential is particularly suitable when the charged particles have a negative charge, i.e. are anions as described herein.

Alternatively, in this charging step, the (initially) uncharged porous electrically conducting material has an applied potential of in the range of between −0.1 and −10 V with respect to a reference electrode, preferably between −0.2 and −5 V, more preferably between −0.3 and −1 V, e.g. about −0.3V, about −0.4 V, about −0.5 V, or about −0.6 V. Particularly preferably the applied potential is about −0.4 V with respect to a reference electrode. The use of an applied negative potential is particularly suitable when the charged particles have a positive charge, i.e. are cations as described herein.

Preferably, the method of making a charged sorbent material further comprises removing the charged electrically conducting porous material from the electrolyte solution; and washing the charged porous electrically conducting material with a solvent to remove residual electrolyte solution.

The inventors have found that this washing step surprisingly improves the capacity of the charged porous electrically conducting material with respect to adsorbance capacity, for example of carbon dioxide, when compared to the same material prepared without the inclusion of this washing step. Without wishing to be bound by theory, it is thought that the washing step removes residual electrolyte solvent and undesirable residual charged species (e.g. cations when the charged particles are anions, and vice versa), and this increases the diffusion efficiency of the species into the charged porous electrically conducting material.

The method of making a charged sorbent material preferably further comprises drying the charged porous electrically conducting material. Preferably, the charged porous electrically conducting material is dried at a temperature of at least about 60° C., preferably at least about 70° C., more preferably at least about 80° C., still more preferably at least about 90° C. and even still more preferably at least about 100° C. The drying temperature is sufficient to remove residual solvent (i.e. from the electrolyte solution) from the charged porous electrically conducting material.

The drying step as described above may be carried out under reduced pressure, for example under vacuum. Vacuum drying is a technique that is known to a person having ordinary skill in the art. Alternatively, the drying step as described above may be carried out under a flow of inert gas, such as argon or nitrogen, preferably nitrogen. The drying step is preferably carried out under reduced pressure and particularly preferably is carried out under vacuum.

Preferably, the charged porous electrically conducting material is dried for a period of time of from about 1 to 48 hours, preferably of from about 12 to 36 hours, e.g. about 24 hours.

A particularly preferred drying step as described above is carried out at a temperature of between about 70 and 80° C. (e.g. about 75° C.) under vacuum for a period of time of about 24 hours.

Without wishing to be bound by theory, it has been found that the combination of the charging step, the optional washing step, and the drying step all as described above result in a charged porous material that is particularly suitable for use as an adsorbent material, for example for the adsorption of carbon dioxide, particularly for the adsorption of carbon dioxide from air at atmospheric temperature and pressure.

A further aspect of the invention is a charged sorbent material obtained or obtainable by the method as hereinbefore described.

A further aspect of the invention is a process of removing an adsorbate from a fluid, comprising contacting a fluid containing the adsorbate with the charged sorbent material as hereinbefore described.

The term “adsorbate” as used herein refers to a molecule, chemical compound, chemical species and the like, that is initially present in a fluid at a first concentration. One particularly preferred adsorbate is carbon dioxide, CO₂. Another particularly preferred adsorbate is hydrogen (i.e. molecular hydrogen), H₂. Another particularly preferred adsorbate is hydrogen sulfide, H₂S.

The process of contacting the fluid with the charged sorbent material as hereinbefore described results a reduction of the concentration of the adsorbate in the fluid, such that after contacting the fluid with the charged sorbent material for a suitable period of time (i.e. at a suitable flow rate of the fluid with respect to the charged sorbent material), the adsorbate is then present in the fluid at a second concentration, wherein the second concentration is lower than the first concentration.

The second concentration is preferably less than about 95% of the first concentration, and more preferably less than about 90% of the first concentration, less than about 80% of the first concentration, less than about 70% of the first concentration, less than about 60% of the first concentration, less than about 50% of the first concentration, less than about 40% of the first concentration, less than about 30% of the first concentration, less than about 20% of the first concentration, less than about 10% of the first concentration, less than about 5% of the first concentration, or less than about 1% of the first concentration.

For the avoidance of doubt, the first concentration of the adsorbate in the fluid may be reduced by contact with the charged sorbent material by any mechanism and the use of the term “adsorbate” is not intended to limit the process to any one particular mechanism by which the adsorbate is removed from the fluid such that the first concentration is reduced.

Without wishing to be bound by theory, it is thought that the charged species (i.e. the charged species of the charged sorbent material as hereinbefore described) interacts with the adsorbate and thus removes it from the fluid, thereby reducing the first concentration. By “interacts” it is meant that there is an at least temporary interaction, such as an electrostatic interaction, i.e. covalent or non-covalent bond formation, between the charged species and the adsorbate. The nature of this interaction is not critical to the functioning of the process of the invention; it is only required that such an interaction be sufficient to reduce the first concentration (i.e. the initial concentration of the adsorbate in the fluid).

Preferably, the interaction of the adsorbate with the charged species is such that the interaction (e.g. electrostatic interaction, bonding interaction) between the adsorbate and the species is retained throughout the process of the invention. In other words, under the conditions of the process of the invention, the adsorbate is irreversibly removed from the fluid, to the extent that the reduction of the first concentration to the second concentration is maintained throughout the duration of the process. That is, in the process of the invention, the adsorbate is removed from the fluid until an optional regeneration step is applied to the charged sorbent material, and not before.

The fluid may be a liquid, plasma or a gas, preferably a liquid or a gas, and more preferably is a gas. For the avoidance of doubt, the terms “liquid” and “gas” as used herein with respect to the process of the invention are used in their standard meaning and refer to the state of the fluid during the process of the invention. The possibility that the fluid may partially or wholly transition from a liquid to a gas, or vice versa, during the process of the invention is not excluded.

When the fluid is a gas, it may preferably be air, a flue gas, or an exhaust gas.

The flue gas may be an output stream for any chemical process, for example a combustion process, such as a hydrocarbon combustion process. The hydrocarbon combustion process may be, for example, the combustion of coal or gas (e.g. natural gas, synthetic gas mixtures and the like) in a power station. Thus the fluid may be a flue gas from a “fossil fuel” power station. The fluid may also be a flue gas from an industrial process (e.g. cement or steel manufacturing).

The exhaust gas may be an exhaust stream from any stationary or mobile emissions source. An example of a mobile emissions source may be an internal combustion engine, such as a petrol or diesel engine in a light duty or heavy duty vehicle.

In a particularly preferred embodiment of the process of the invention, the fluid is air and the adsorbate is carbon dioxide. In this embodiment of the process of the invention, the process is a direct air carbon capture process comprising contacting air with the charged sorbent material to remove carbon dioxide from said air (i.e. reduce the concentration of carbon dioxide in said air from a first concentration to a second concentration, as described above).

Preferably the process of the invention is carried out at a temperature in the range of −20 to 50° C., more preferably in the range of −10 to 40° C., still more preferably in the range of −5 to 35° C., such as 0 to 30° C., or 5 to 25° C. It is particularly preferable that the process be carried out at whatever the initial temperature of the fluid is. In other words, it is preferred that the charged sorbent material be suitable for use with the fluid at whatever the incident temperature of the fluid is at the point where it is contacted with the charged sorbent material, i.e. no additional heating or cooling steps or apparatus are needed. Particularly preferably, the process of the invention is carried out at ambient temperature.

In the embodiment of the process of the invention wherein the fluid is air and the adsorbate is carbon dioxide, it is preferred that the invention is carried out at ambient (i.e. air, atmospheric) temperature.

Preferably the process is carried out at atmospheric pressure. For the avoidance of doubt, the process of the invention may also be carried out at reduced or increased pressure of the fluid, i.e. the fluid may optionally be pressurised prior to contact with the charged sorbent material.

In the embodiment of the process of the invention wherein the fluid is air and the adsorbate is carbon dioxide, it is preferred that the invention is carried out at ambient (i.e. air, atmospheric) pressure.

Thus in one particularly preferred embodiment of the invention, the fluid is air, the adsorbate is carbon dioxide, and the process is carried out at ambient (i.e. air, atmospheric) temperature and pressure. Such a process may be described as a direct air carbon capture process, or DAC process.

Optionally, the process may further comprise a step of regenerating the charged sorbent material by removing greater than about 60% of the adsorbate from the charged sorbent material. Preferably greater than about 70% of the adsorbate, more preferably greater than about 80%, greater than about 85%, greater than about 90%, greater than about 95%, greater than about 97%, or greater than about 99% of the adsorbate is removed from the charged sorbent material.

It will be appreciated by the skilled person that a regeneration step will consume energy and that there may be diminishing returns in the energy efficiency of this optional regeneration step as the amount of removal of the adsorbate from the charged sorbent material approaches 100%.

The optional regeneration step of the process may comprise a step wherein the charged sorbent material is thermally regenerated by heating to a temperature in the range of 20 to 250° C. Preferably the charged sorbent material is thermally regenerated by heating to a temperature in the range of 30 to 200° C., more preferably 40 to 150° C., still more preferably 50 to 125° C., and still more preferably 90 to 110° C., e.g. about 200° C., about 150° C., about 125° C., about 115° C., about 110° C., about 105° C., or about 100° C.

The optional regeneration step as described above may be carried out under reduced pressure, for example under vacuum. Alternatively, the regeneration step as described above may be carried out under a flow of inert gas, such as argon or nitrogen, or may be carried out under carbon dioxide, preferably under pure carbon dioxide (i.e. carbon dioxide having a purity of greater than 90%). The regeneration step is preferably carried out under reduced pressure and particularly preferably is carried out under vacuum.

The optional regeneration step of the process may comprise a wherein the charged sorbent material is regenerated by applying a voltage or direct current across the charged sorbent material. This may be described as a joule heating regeneration step. Preferably this joule heating regeneration step is carried out under a vacuum, under a pure carbon dioxide atmosphere, or under a nitrogen atmosphere. Preferably the voltage or direct current is applied to the charged sorbent material until the charged sorbent material reaches a contact temperature (i.e. surface temperature) of at least about 30° C., preferably at least about 40° C., more preferably at least about 50° C., still more preferably at least about 60° C., yet more preferably at least about 70° C., and more preferably at least about 80° C., e.g. at least about 50° C., at least about 60° C., at least about 70° C., at least about 80° C., at least about 85° C., at least about 90° C., at least about 95° C., at least about 100° C., at least about 105° C., or at least about 110° C.

Particularly preferably, where the process comprises a joule heating regeneration step as hereinbefore described, the electricity used is from a renewable energy source, such as wind, solar, or tidal energy.

### EXAMPLES

### Materials

Activated carbon fabric ACC-5092-10 cloth was purchased from Kynol®. The cloth was activated for 1 h at 100° C. in a vacuum oven before use. Potassium hydroxide (99%), potassium bicarbonate (99%) and sodium hydroxide (99%) were purchased from Sigma-Aldrich®. YP80F activated carbon powder was obtained from Kuraray Chemical, Japan. All chemicals were of analytical grade and directly used as received without further purification.

### Preparative Example 1

Charged sorbents were prepared in a three-electrode configuration with a home-made electrochemical cell (total volume is 50 mL). The activated carbon fabric ACC-5092-10 cloth (dimensions: 2 cm×2 cm) was applied with a constant potential (0.565 V vs SHE for positively charged sorbent and −0.235 V vs SHE for negatively charged sorbents, respectively) in 40 mL of 6 M KOH via chronoamperometry for 4 h. After completing the charging process, the disassembled charged cloth was held by plastic tweezers and rinsed by washing bottle for 5 min on both sides. 500 mL deionized water in total was used to wash off the residual KOH. The rinsed cloth was then placed in the vacuum oven at 75° C. to remove the water solvent for 24 h, to yield the final positively charged-sorbent (PCS) bearing hydroxide ions, referred to as PCS-OH.

The counterpart negatively charged sorbent was prepared by applying a potential of −0.235 V vs. SHE for 4 h, followed by the same washing and drying procedure described above, to yield a negatively charged-sorbent replete with potassium ions, referred to as NCS-K.

For the uncharged sorbents (i.e. not according to the invention; comparative examples), the activated carbon fabric ACC-5092-10 cloth (dimensions: 2 cm×2 cm) was soaked in 40 mL of 6 M KOH for 4 h. After soaking, the rinsing and drying processes were the same as charged sorbents. This comparative example is referred to as the ‘soaked cloth’ herein.

As a further comparative example (i.e. another uncharged sorbent), a sample was prepared by adapting the protocol outlined in Shi et. Al. (Shi, X. et al. Moisture-driven CO₂ sorbents. Joule 4, 1823-1837 (2020). Here, 200 μL of 6 M KOH was dripped onto the surface of 340.0 mg ACC-5092-10 obtained from Kynol. Subsequently, the samples were left in a Schlenk flask which connected to vacuum to let the samples dry for 72 hours at room temperature. This comparative example is referred to as the ‘dripped cloth’ herein.

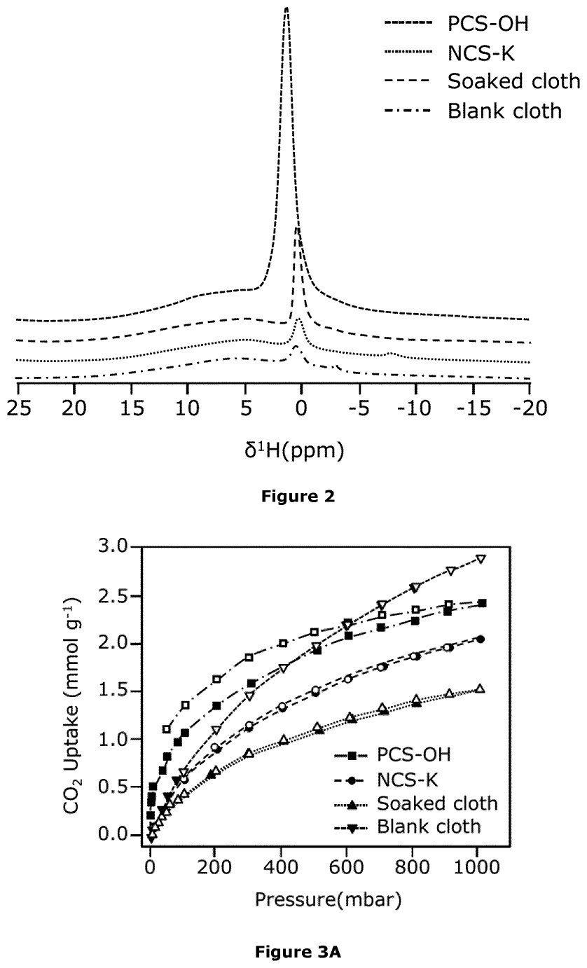

Evidence for the incorporation of hydroxide ions in PCS-OH was obtained from ¹H solid-state NMR measurements (FIG. 2). For PCS-OH, a strong resonance was observed at ~1.5 ppm, which corresponds to OH⁻ species present in the pores. To confirm this assignment, additional measurements were carried out on (i) the as-purchased activated carbon cloth, (ii) a carbon cloth that was soaked in the electrolyte but not charged, and (iii) a carbon cloth that was charged at a negative potential. In these three controls, much weaker ¹H resonances were observed between 0 and 1 ppm, which are assigned to residual H₂O species in the carbon pores for the blank carbon cloth, and residual H₂O and/or OH⁻ species undergoing fast chemical exchange for the soaked and negatively charged samples. The stronger signal intensity observed for the PCS-OH sample supports the charge-driven accumulation of OH⁻ species in the electrode.

This assignment is in line with combustion analysis, which also indicated an increased amount of hydrogen in PCS-OH compared to the other materials.

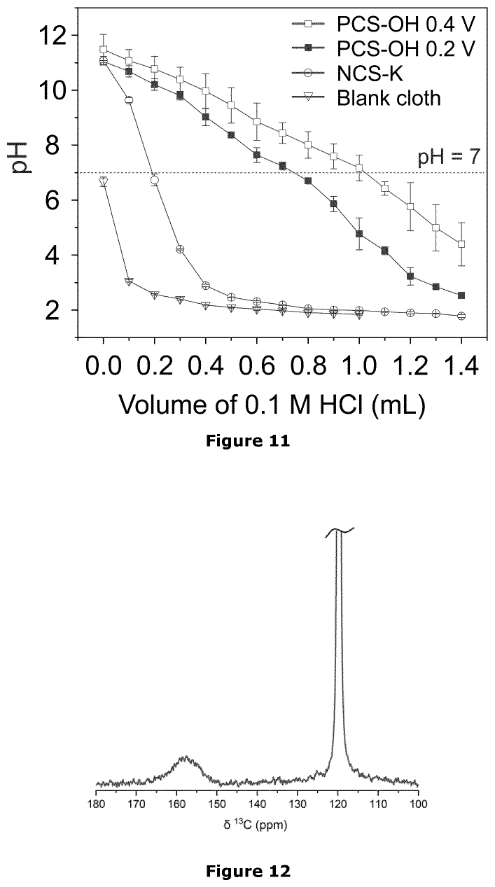

Further support for the accumulation of OH⁻ species in PCS-OH was provided by titration experiments carried out as outlined above. These results are shown in FIG. 11. Briefly, 1.2 mmol/g of HCl was required to neutralise PCS-OH, compared to 0.2 mmol/g for NCS-K.

### Preparative Example 2

Free-standing carbon films were prepared by adapting the published literature method (Forse, A. C. et al. NMR Study of Ion Dynamics and Charge Storage in Ionic Liquid Supercapacitors. J. Am. Chem. Soc. 137, 7231-7242 (2015). YP80F activated carbon powder (95 wt %) (Kuraray Chemical, Japan) was mixed with polytetrafluoroethylene binder (5 wt %) (Sigma-Aldrich, 60 wt % dispersion in water) in ethanol. The resulting slurry was kneaded and rolled to give a carbon film of approximately 0.25 mm thickness, followed by removing residual solvent at 100° C. in vacuum for at least 24 h.

Disk-shaped electrodes were then cut from the carbon films using a 0.25 inch punch. Symmetrical Swagelok electrochemical cells were then prepared with stainless steel current collectors, YP80F film electrodes (for both the positive and negative electrodes), 6 M KOH (aq.) electrolyte, and a glass fibre separator (Whatman glass microfiber filter (GF/A)). Cells were charged at a constant cell voltage of 0.8 V for 4 hours in two electrode mode, and the positive electrode was then extracted, washed, and dried, as above, to yield a charged sorbent referred to as PCS-OH (YP80F). Three samples from three independent electrochemical cells were combined to provide sufficient material for gas sorption measurements.

### Methods

Electrochemistry: All electrochemical measurements were performed at room temperature using a BioLogic SP-150 potentiostat and a Biologic BCS-800 Series. A coiled platinum wire (BASi, MW-1033) was used as a counter electrode. The reference electrode was Hg/HgO (ALS, RE-61AP) with 0.1 M KOH filling solution; the filling solution was exchanged routinely to keep the potential constant. Potentials are converted to the standard hydrogen electrode (SHE) using the correction E_{SHE}=E_{Hg/HgO}+0.165 mV.

Elemental analysis: C, H and N concentrations were determined via CHN combustion analysis using an Exeter Analytical CE-440, with combustion at 975° C.

Gas sorption: CO₂ adsorption isotherms were collected on an Autosorb iQ gas adsorption analyzer. Isotherms conducted at 25, 35, and 45° C. were measured using a circulating water bath. Samples were activated at 100° C. for 15 h prior to any gas sorption measurements.

Thermogravimetric CO₂ adsorption: Thermogravimetric CO₂ adsorption experiments were conducted with a flow rate of 60 mL/min using a TA Instruments TGA Q5000 equipped with a Blending Gas Delivery Module. Samples were activated under flowing N₂ for 30 min at various temperatures prior to cooling to 30° C. and switching the gas stream to pure CO₂.

Cycling capacities for positively charged sorbents were carried out on a Mettler Toledo TGA/DSC 2 Star^{ed} system equipped with a Huber mini chiller. The adsorption and desorption of CO₂ were performed at 30° C. and 100° C. for 20 min under 30% CO₂ and 70% N₂ with a flow rate of 140 mL/min, respectively.

NMR spectroscopy: Solid-state NMR experiments were performed with Bruker Advance spectrometers operating at magnetic field strengths of 9.4 T, corresponding to a ¹H Larmor frequency of 400.1 MHz. A Bruker 4 mm HX double resonance probe was used in all cases. ¹H NMR spectra were referenced relative to neat adamantane (C₁₀H₁₆) at 1.9 ppm and ¹³C NMR spectra were referenced relative to neat adamantane (C₁₀H₁₆) at 38.5 ppm (left-hand resonance). All of the NMR tests were conducted with a sample magic angle spinning rate of 12.5 kHz. A 90° pulse-acquire sequence was applied in each experiment. For ¹³C NMR experiments, recycle delays were set to be more than five times the spin-lattice relaxation time for each sample to ensure that the experiments were quantitative.

¹³CO₂ dosing for solid-state NMR experiments: The samples were packed into 4 mm NMR rotors and then evacuated for a minimum of 10 min in a home-built gas manifold. ¹³C-enriched CO₂ gas was then used to dose the samples with gas at room temperature until the gas pressure stabilised, before sealing the rotors inside the gas manifold with a mechanical plunger.

Direct air capture (DAC) test: The DAC tests were carried out in a sealed box (volume 600 mL) with the CO₂ sensor (Aranet4) to record the concentration of CO₂, temperature and relative humidity (RH) at every one-minute interval. Before each cycle, the box was exposed to the fresh air until the CO₂ concentration, RH and temperature were stable. The sorbent was then placed in the box which was properly sealed to prevent air leakage.

Joule heating: After each DAC adsorption step, the sorbent was extracted from the box and then connected with inert electrical copper wires and clips for the joule heating. The BioLogic SP-150 potentiostat was used to vary the electrical input. The constant voltage that was applied was adjusted during the experiment to achieve a sample temperature in a range of 85-95° C. under an N₂ atmosphere. The temperature was monitored using a thermocouple at a single contact point. After joule heating regeneration, the electrode was ready to be reused in another DAC adsorption cycle. In addition, one group of DAC tests were performed with relative humidity controlled by desiccant (silica gel) to compare the recycling capacity of joule heating.

Adsorption microcalorimetry measurements: The simultaneous measurement of the heat of adsorption and the adsorbed amount of carbon dioxide was performed by means of a heat flow microcalorimeter (Calvet C80 by Setaram), connected to a high-vacuum (residual pressure <10⁻⁴ mbar) glass line equipped with a Varian Ceramicell 0-100 mbar gauge and a Leybold Ceramicell 0-1000 mbar gauge. Before the measurement, both PCS-OH and blank carbon cloth (ca. 150 mg before activation) were activated for 24 h under high vacuum (residual pressure <10⁻³ mbar) at 100° C. (temperature ramp 3° C./min). The adsorption microcalorimetry measurements were performed at 30° C. by following a well-established step-by-step procedure described in detail elsewhere³². This procedure allows, during the same experiment, the determination of both integral heats evolved (−Qᵢₙₜ) and adsorbed amounts (nₐ) for small increments of the adsorptive pressure. The partial molar heats obtained for each small dose of gas admitted over the sample are computed by applying the following ratio: ΔQᵢₙₜ/Δnₐ, kJ mol⁻¹. The (differential) heats of adsorption are then reported as a function of CO₂ adsorbed amount, to obtain the (differential) enthalpy changes associated with the proceeding adsorption process. The equilibration time in the microcalorimetric measurement was set to 24 hours for small equilibrium pressures (<30 mbar), whereas it was reduced to 2 hours for larger doses for PCS-OH. The equilibration time was reduced to 2 hours (regardless of the equilibrium pressure) for the bare carbon cloth, as equilibration is expected to occur faster in absence of specific adsorption sites.

Titration Measurements. First, 88 mg of the sample to be tested was immersed in 2 mL deionized water and sonicated for 20 min at 25° C. The pH value was then recorded with a pH meter (Insmark IS128C, calibrated with Buffer solutions before use) at 25° C. as the initial point. Second, 100 μL HCl (0.1 M) was slowly added. The mixture was sonicated for 20 min at a constant 25° C. and the pH of the solution was recorded. The second step was repeated until the end of the titration. There was no weight loss due to evaporation during the titration.

### Results

### Example 1

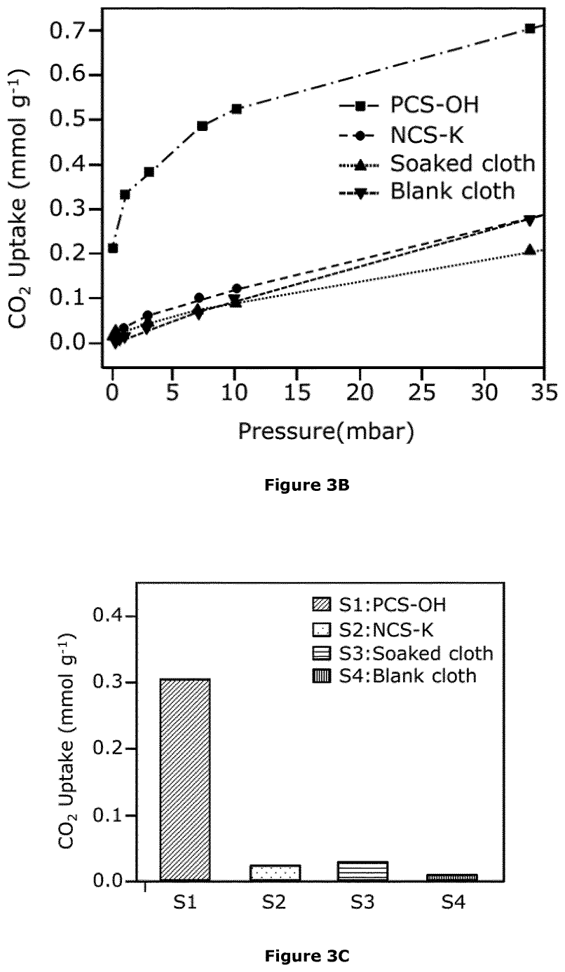

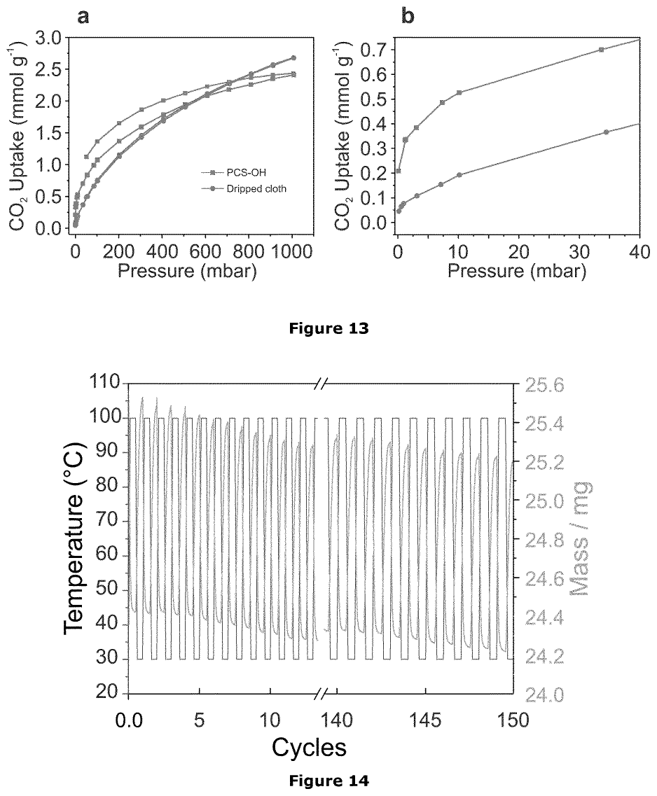

PCS-OH was prepared in accordance with Preparative Example 1. CO₂ adsorption isotherm measurements demonstrated enhanced and reversible CO₂ capture at low pressures for PCS-OH, relative to the control samples. Importantly, PCS-OH exhibited increased CO₂ uptake at CO₂ partial pressures relevant to DAC. At 0.4 mbar and 25° C., the CO₂ capacity for PCS-OH is 0.31±0.06 mmol g⁻¹, which is significantly larger than the capacities of the NCS-K, soaked carbon cloth and initial carbon cloth under these conditions. These results are shown in FIG. 3. Similar results are seen when comparing the PCS-OH sample with a ‘dripped cloth’; PCS-OH shows a greater low-pressure CO₂ uptake than the ‘dripped cloth’ (see FIG. 13).

Experiments with potential holds for shorter durations than 4 h resulted in lower adsorption capacities. Experiments at lower applied potentials than +0.565 V also revealed lower capacities.

PCS-OH was prepared in accordance with Preparative Example 1 but using a voltage potential of 0.365V vs SHE (standard hydrogen electrode) and carbon dioxide uptake was studied using NMR following the method outlined above. The results are shown in FIG. 12. The measurements show a smaller quantity of chemisorbed CO₂ compared to NMR measurements on PCS-OH synthesized by applying a potential of 0.565 V vs. SHE (standard hydrogen electrode).

To investigate the nature of CO₂ sorption in PCS-OH adsorption microcalorimetry measurements were carried our using the above protocol using PCS-OH prepared by the method of Preparative Example 1. These measurements allow the direct quantification of the heat released during CO₂ uptake measurements. The results are shown in FIG. 18. A blank carbon cloth (i.e. an untreated cloth used as provided by the manufacturer) was used as a control. For the blank carbon cloth control, the measured CO₂ adsorption heat is between −28 and −20 kJ mol⁻¹, consistent with CO₂ physisorption. A large increase in the adsorption heat is observed for PCS-OH relative to the blank carbon, consistent with CO₂ chemisorption. The measured adsorption heats gradually decrease from a value of −137 kJ mol⁻¹ at zero coverage (extrapolated value) to −33 kJ mol⁻¹ at a coverage of 0.8 mmol g⁻¹ suggestive of bicarbonate formation at a distribution of hydroxide sites. Importantly, the adsorption heats compare well with previous reports for bicarbonate formation in porous materials and metal oxides, lending support that the electrochemically inserted hydroxides in PCS-OH serve as CO₂ chemisorption sites to enhance low-pressure uptake.

### Example 2

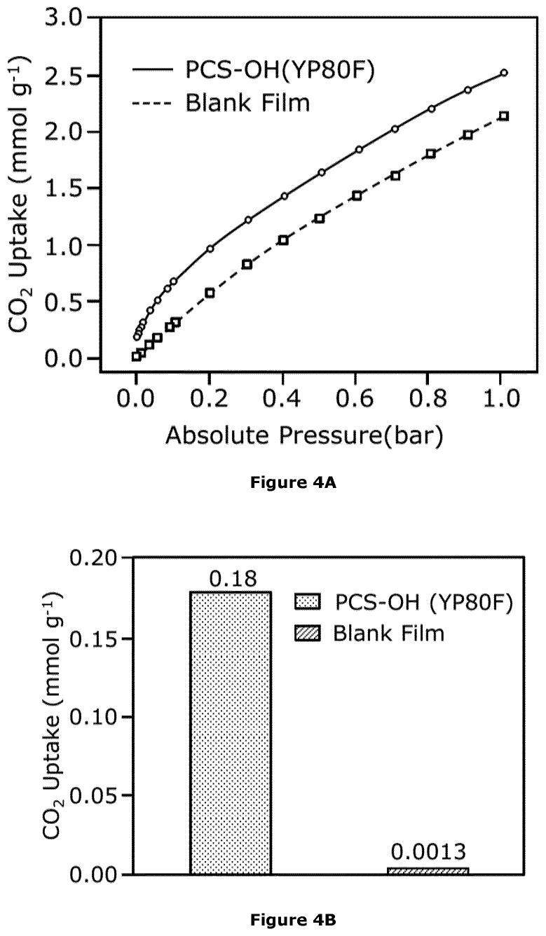

PCS-OH (YP80F) was prepared in accordance with Preparative Example 2. CO₂ adsorption isotherm measurements as described above in Example 1 also demonstrated enhanced low pressure CO₂ uptake PCS-OH (YP80F). These results are shown in FIG. 4.

### Example 3

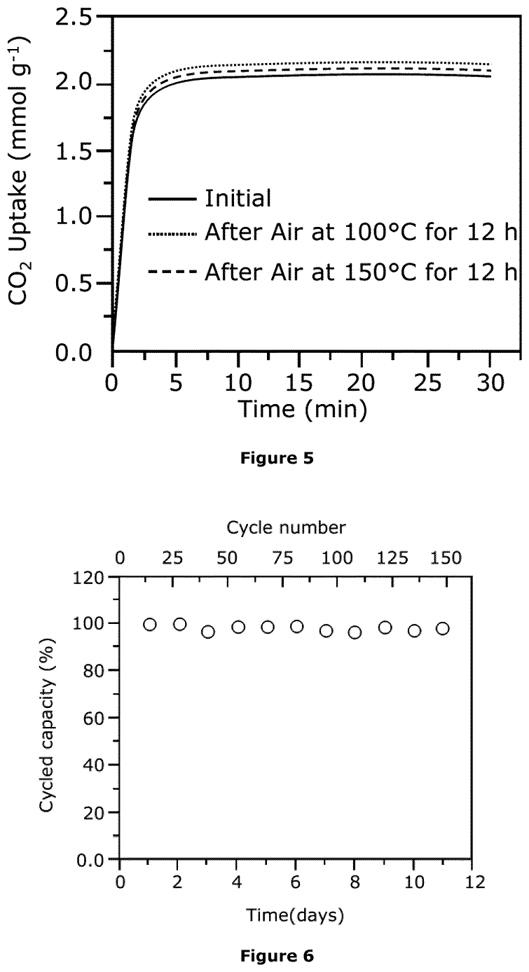

Thermogravimetric analysis (TGA) measurements were conducted on PCS-OH to determine the thermal stability of the material. PCS-OH was heated to 150° C. under flowing dry air at atmospheric pressure for 12 h. Dry, pure CO₂ adsorption isobars before and after air exposure were measured, and showed very similar capacities and uptake kinetics, confirming the good oxidative stability of the material. These results are shown in FIG. 5.

This oxidative stability is in contrast to the behaviour of amine-based sorbents, which typically display poor oxidative stability, a recurring challenge for their application for DAC. The charged sorbent materials of the present invention are therefore an improvement over prior art materials with respect to oxidative stability.

### Example 4

A temperature-pressure swing adsorption process was carried out to test the cycling stability of PCS-OH. As such, PCS-OH was subjected to 150 adsorption and desorption cycles using TGA under concentrated CO₂ conditions (30% CO₂ in N₂). These results are shown in FIG. 6 and FIG. 14.

Consistent with the thermal stability test of Example 3, PCS-OH exhibited a stable cycling capacity (assuming negligible N₂ uptake), with minimal performance loss after 150 cycles.

Overall, these data support that PCS-OH exhibits remarkable stability and affinity towards CO₂ at pressures relevant to DAC, and indicate that PCS-OH has good thermal and oxidative stability and hence is suitable for use in DAC processes.

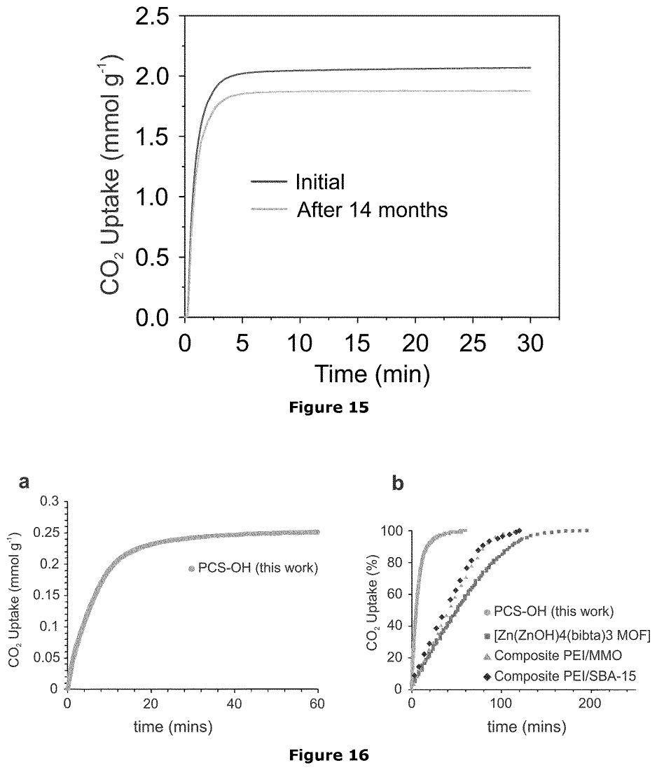

Additionally, the CO₂ uptake of PCS-OH was evaluated over time by measuring the CO₂ uptake curve in dry, pure CO₂ at 40° C. and 1 bar CO₂ for PCS-OH before and after a period of sample storage in air for 14 months using TGA. The results are shown in FIG. 15. The capacity after 14 months is reduced but the reduction is not substantial indicating that these materials maintain good capacity during storage.

### Example 5

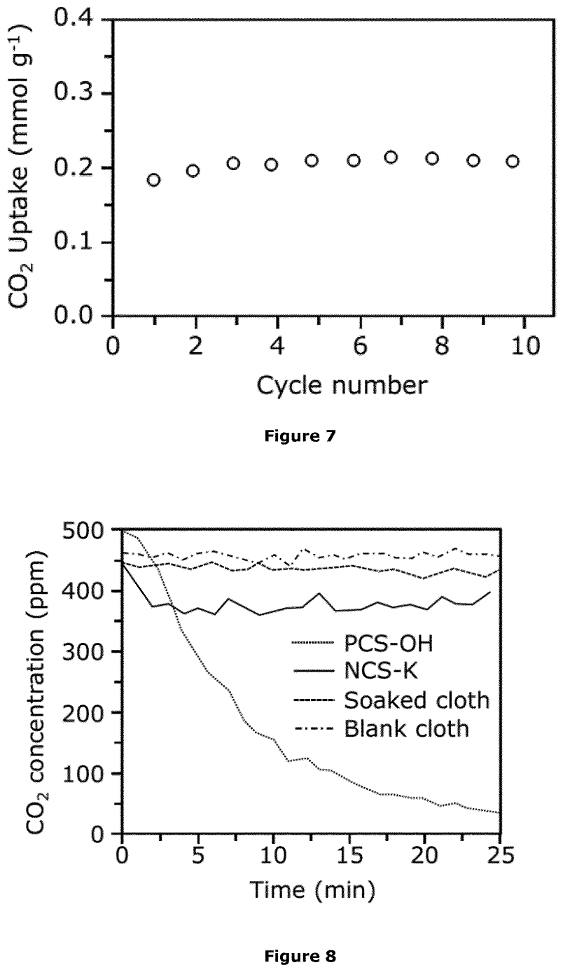

DAC performance of PCS-OH was evaluated under simulated dry air with 400 ppm CO₂ in air at 30° C. via TGA experiments, with desorption conducted under 100% N₂ at 130° C. These measurements revealed a CO₂ capacity of approximately 0.2 mmol g⁻¹, which was stable over repeated adsorption and desorption cycles (FIG. 7). The kinetics for CO₂ capture of PCS-OH are excellent, and a significant improvement over prior art materials. The fast uptake at the low partial pressure of CO₂ gives a CO₂ capture rate of 7.5 mmol CO₂ g⁻¹h⁻¹, which is around 7 times faster than for amine-functionalized sorbents (Table 1).

TABLE 1

| | Kinetics for | | | |
|---|---|---|---|---|
| | CO2 capture | | | |
| Samples | (mmol CO₂ g⁻¹ h⁻¹) | | Conditions | Reference |
| Composite PEI/Oxide* | 0.96 | (30° C.) | 400 ppm CO₂ | Ref. 1 |
| Composite PEI/MMO* | 1.1 | (25° C.) | 400 ppm CO₂ | Ref. 2 |
| PCS-OH | 7.5 | (40° C.) | 400 ppm CO₂ | n/a |

*comparative example of amine-functionalised sorbent
Ref. 1: ACS Appl. Mater. Interfaces 7, 24748-24759 (2015).
Ref. 2: J. Mater. Chem. A 8, 16421-16428 (2020).

### Example 6

A further DAC test was conducted, in which PCS-OH and three control samples were subjected to ambient air in a sealed system equipped with a CO₂ sensor. For PCS-OH, a large decrease in CO₂ concentration was observed, with a decrease from 500 ppm to around 25 ppm in 25 min. In contrast, the CO₂ concentration decreased much less (74 ppm) for the NCS-K control sample, while the soaked and blank cloth controls did now show any measurable CO₂ capture from air (FIG. 8).

These measurements further support the idea that the charging process described herein enhances carbon capture at low partial pressures, and therefore enables the use of the charged sorbents of the present invention in DAC.

### Example 7

The electrically conductive nature of charged sorbent materials of the invention permits regeneration by direct Joule heating. This may allow more rapid and efficient regeneration than heating externally.

Electrodes were attached to a piece of PCS-OH (2 cm×1 cm) prepared according to Preparative Example 1. A DC voltage of 7-8 V was applied, resulting in the rapid heating of the material to ~90° C.

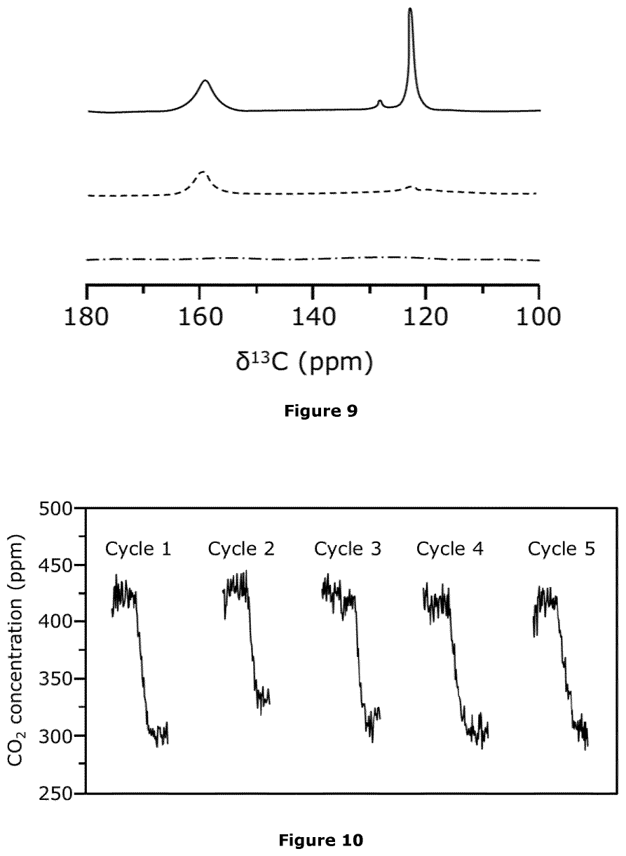

Solid-state NMR experiments on samples pre-dosed with ¹³CO₂ gas showed that this Joule heating at ~90° C. for 20 mins lead to the complete release of chemisorbed and physisorbed CO₂. These results are shown in FIG. 9.

The titration results (FIG. 11) allow an estimate of the hydroxide context in PCS-OH of 1.2 mmol g⁻¹. This leads to an estimated molecular formula of (OH)C₆₈. The NMR experiments on PCS-OH allow an estimate of the lower limit for the hydroxide content in PCS-OH of 0.95 mmol g⁻¹ (assuming a 1:1 reactivity of CO₂ and hydroxide), which is comparable to the value of 1.2 mmol g⁻¹ from titration (FIG. 11). This further leads to an estimated molecular formula for PCS-OH of (OH)C₈₆. The NMR experiments on PCS-OH prepared at a lower charging potential (FIG. 12) provide a lower, but still reasonable, limiting hydroxide content of 0.38 mmol g⁻¹ and an estimated molecular formula of (OH)C₂₁₈.

### Example 8

A proof-of-concept DAC cycle with CO₂ capture from ambient air, and regeneration by Joule heating in nitrogen, was conducted. The regenerated PCS-OH was then reused in the next DAC cycle, for 5 cycles. These experiments displayed a stable cycling capacity (0.23 mmol g⁻¹), with retention of the CO₂ capacity of PCS-OH (i.e. a charged sorbent of the present invention) after 5 cycles. These results are shown in FIG. 10.

Additional DAC cycle testing following the above method was carried out to look at the kinetics of CO₂ capture from ambient air for PCS-OH shortly after preparation and when stored for 14 months. Comparative tests were carried on various known absorbents. The results are shown in FIG. 16. These results highlight the excellent kinetic performance of PCS-OH.

Importantly, PCS-OH can still do DAC (FIGS. S16a and b) at comparable capacity after 14 months, despite the small capacity lost seen under pure CO₂ conditions. The DAC kinetics for PCS-OH are also excellent, with a faster CO₂ capture rate than several benchmark sorbents (FIG. 16b). This good capacity combined with the rapid kinetics for PCS-OH indicate that a highly productive DAC process may be achieved.

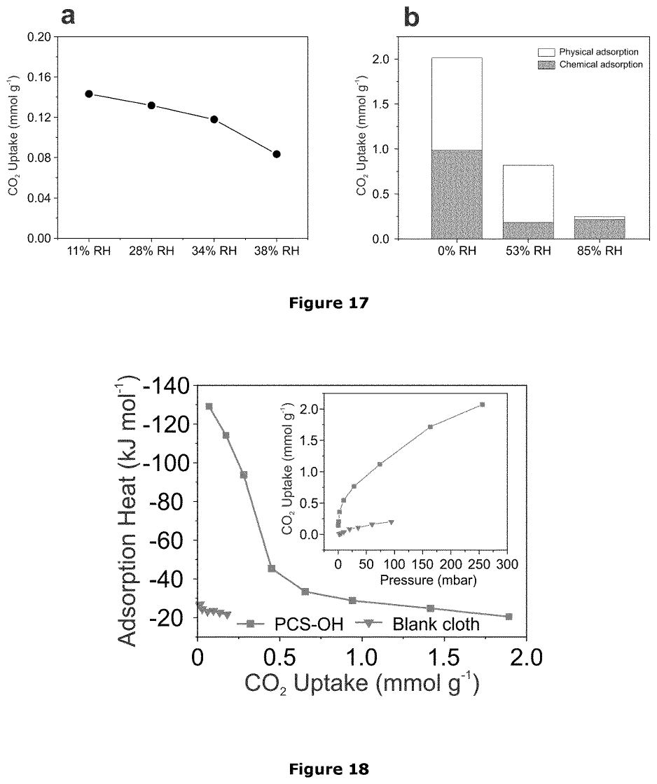

Additionally, experiments were carried out to study the effect of relative humidity on CO₂ uptake at different CO₂ concentrations. The results are shown in FIG. 17. FIG. 17a is data from DAC experiments carried out as outlined above for PCS-OH, with 20 min Joule heating regeneration under nitrogen between cycles. PCS-OH was added into the box at a time of 25 min for each cycle. The mass of PCS-OH in these experiments was 33 mg. FIG. 17b is data from solid-state NMR experiments of sorbents with ¹³CO₂ gas dosing at 0.9 bar, acquired at a MAS rate of 12.5 kHz. Prior to ¹³CO₂ dosing, the sorbents were pre-humidified using saturated salt solution (approximately 53% RH at 25° C.).

The CO₂ capacity decreased as the RH increased at ambient CO₂ concentration (i.e. suitable for DAC; FIG. 17a) compared to high CO₂ concentrations (FIG. 17b). Specifically, the CO₂ capacity decreased from approximately 0.14 to 0.08 mmol/g as the RH increased from 11 to 38% under ambient CO₂ concentration (FIG. 17a). Consistent with this, solid-state ¹³C solid-state NMR experiments at 0.9 bar CO₂ and 53% RH showed decreased chemisorption (0.19 mmol/g compared to 0.95 mmol/g at 0% RH, (FIG. 17b).

1-27. (canceled)

28. A charged sorbent material, comprising
a charged porous electrically conducting material; and
charged particles within the porous electrically conducting material;
wherein the porous electrically conducting material comprises one or more of a carbon material, a metal organic framework (MOF), a covalent organic framework (COF), one or more organic or inorganic binders, or a conducting polymer.

29. The charged sorbent material of claim 28, wherein the charged porous electrically conducting material comprises a carbon material, and wherein said carbon material comprises activated carbon.

30. The charged sorbent material of claim 29, wherein the carbon material comprises an activated carbon fiber cloth optionally wherein the activated carbon fiber cloth has a specific surface area of from 500 to 3500 m²/g.

31. The charged sorbent material of claim 28, wherein the charged porous electrically conducting material comprises:
i) a conducting polymer, or one or more organic or inorganic binders; and
ii) activated carbon particles.

32. The charged sorbent of claim 28, wherein porous electrically conducting material is a conducting polymer, wherein the conducting polymer is selected from the list consisting of: PTFE (polytetrafluoroethylene), PFA (perfluoroalkoxy polymer resin), FEP (fluorinated ethylene propylene), ETFE (polyethylenetetrafluoroethylene), PVF (polyvinyl fluoride) ECTFE (polyethylenechlorotrifluoroethylene), PVDF (sold as polyvinylidene fluoride), PCTFE (polychlorotrifluoroethylene), trifluoroethanol, and combinations thereof.

33. The charged sorbent material of claim 31, wherein the charged sorbent material is a film having a thickness of in the range of between 0.1 and 1.0 mm.

34. The charged sorbent of claim 28, wherein the charged particles are selected from organic anions, inorganic anions, organic cations, and inorganic cations optionally wherein the charged particles are complex anions or complex cations.

35. The charged sorbent of claim 34, wherein the charged particles are inorganic cations of lithium, sodium, potassium, rubidium, caesium, beryllium, magnesium, calcium, strontium, or barium.

36. The charged sorbent of claim 34, wherein the charged particles are organic anions or inorganic anions selected from the list comprising hydroxide, fluoride, chloride, bromide, iodide, carbonate, or bicarbonate.

37. The charged sorbent of claim 36, wherein the charged particles are hydroxide anions.

38. A method of making a charged sorbent material, comprising contacting an uncharged porous electrically conducting material with an electrolyte solution; electrically connecting the uncharged porous electrically conducting material to an electrode; and applying an electric potential across the uncharged porous electrically conducting material and the electrode to form a charged porous electrically conducting material.

39. The method of making a charged sorbent material according to claim 38, further comprising removing the charged electrically conducting porous material from the electrolyte solution; and washing the charged porous electrically conducting material with a solvent to remove residual electrolyte solution.

40. The method of making a charged sorbent material according to claim 38, further comprising drying the charged porous electrically conducting material.

41. A charged sorbent material obtained or obtainable by the method of claim 38.

42. A process of removing an adsorbate from a fluid, comprising contacting a fluid containing the adsorbate with the charged sorbent material of claim 28.

43. The process of claim 42, wherein the fluid is a gas optionally wherein the gas is air, a flue gas, or an exhaust gas.

44. The process of claim 42, wherein the adsorbate is carbon dioxide or hydrogen.

45. The process of claim 42, wherein the process is a direct air carbon capture process comprising contacting air with the charged sorbent material to remove carbon dioxide from said air; optionally wherein the process is carried out at a temperature in the range of −20 to 50° C.; and/or
wherein the process is carried out at atmospheric pressure.

46. The process of claim 42, further comprising regenerating the charged sorbent material by removing greater than about 60% of the adsorbate from the charged sorbent material; optionally wherein the charged sorbent material is thermally regenerated by heating to a temperature in the range of 20 to 250° C.; and/or wherein the charged sorbent material is regenerated by applying a voltage or direct current across the charged sorbent material.
